(19) United States
(12) Patent Application Publication
(10) Pub. No.: US 2017/0186426 A1
(43) Pub. Date: Jun. 29, 2017

(54) SYSTEM AND METHOD FOR PREDICTIVE DEVICE CONTROL

(71) Applicants: Kabushiki Kaisha Toshiba, Minato-ku (JP); Toshiba TEC Kabushiki Kaisha, Shinagawa-ku (JP)

(72) Inventors: William Su, Riverside, CA (US); Jenny Zhang, Irvine, CA (US)

(21) Appl. No.: 14/981,208

(22) Filed: Dec. 28, 2015

(51) Int. Cl. G10L 15/22; G10L 15/18; G10L 15/26

(52) U.S. Cl. CPC G10L 15/22; G10L 15/26; G10L 15/1822; G10L 2015/223

(57) ABSTRACT

Document interfaces for control of operation of systems or devices can be cumbersome, and users must issue complete device instructions each time, often using interfaces that are not user friendly. A system and method for man-machine interfacing receives natural language input from one or more users. The natural langue input identified relative to a user, and passed to extract information such as instructions to control a device. Incoming user instructions are compared against prior instructions from the same user, and a determination is made as to whether prior information is usable in connection with the current instructions. The system thus anticipates a user's needs based on prior activities of that user. Input from other devices associated with the same user, which can be used to gauge a user's habits, can be used to further refine proposed device activity to enhance a user's experience.

### TECHNICAL FIELD

Example embodiments of this application relates generally to human control of devices or operations. The application has particular utility in connection with natural language device control operations.

### BACKGROUND

Computing power of digital devices continues to increase at a rapid pace, as has the sophistication and capability of software that runs on them. Early computers were best suited for pure mathematical calculations. As computing power increased, devices were enabled to play, record and manipulate audio data, more recently in real time. Further increases in computing power allowed for migration of these capabilities into video.

A particular problem associated with operation of computers and devices has been the man/machine interface. Earliest control was accomplished by switches which merely toggled power to devices or components between on and off. Earliest digital inputs were accomplished similarly by manually setting bit values. Interfaces evolved into more sophisticated electro-mechanical human interaction through punch cards, paper tape and digital keyboards. Hardware and software advances facilitated use of pointing devices such as mice, trackballs and light pens, and even more recently, touchscreens.

Today, hardware and software allows for verbal or natural language inputs to computing devices. Speech-to-text and speech control are becoming common. Apple, Inc. introduced voice control of its smartphones with its introduction of Siri. Siri uses a voice interface to answer questions, make recommendations and perform actions by delegating requests to a set of Web services with limited capabilities, functionality, and usability.

### SUMMARY

Document interfaces for control of operation of systems or devices can be cumbersome, and users must issue complete device instructions each time, often using interfaces that are not user friendly.

In accordance with an example embodiment of the subject application, natural language input is received from a user desiring to interact with a device. Natural language input is used to identify users associated with an input session. Received natural language is parsed to extract instructions. Received instructions are compared with previous instructions received from in identified user, and the result of this comparison generates an output instruction for control of an associated device.

In accordance with another example embodiment, data corresponding to a user's habits, tastes or preferences is used to anticipate the user's needs.

### BRIEF DESCRIPTION OF THE DRAWINGS

Various embodiments will become better understood with regard to the following description, appended claims and accompanying drawings wherein:

FIG. 1 illustrates an example embodiment of a network;

FIG. 2 is block diagram of an example embodiment of a document processing device;

FIG. 3 is a block diagram of an example embodiment of a document processing device functionality;

FIG. 4 is a first example embodiment of a user-machine dialog session;

FIG. 5 is a second example embodiment of a user-dialog session;

FIG. 6 is a third example embodiment of a user-dialog session;

FIG. 7 is a fourth example embodiment of a user-dialog session;

FIG. 8 is a fifth example embodiment of a user-dialog session;

FIG. 9 is a sixth example embodiment of a user-dialog session;

FIG. 10 is a seventh example embodiment of a user-dialog session;

FIG. 11 is an eighth example embodiment of a user-dialog session;

FIG. 12 is a diagram of an example embodiment of an intelligent interface utilizing user data obtained via a network;

FIG. 13 is a block diagram of an example embodiment of operation of a natural language interface for device interaction; and

FIG. 14 is a flowchart of an example embodiment of operation of a predictive, natural language device operation system.

### DETAILED DESCRIPTION

Example embodiments described herein facilitate natural language man/machine interfaces suitable for textual or audio input. In further example embodiments, machine capabilities monitor a user's historic interaction with devices, which can be the actual device being used, as well as the user's interaction with local or remote devices or sensors. This information is used to improve and augment the user's experience in a future man/machine interfacing. Ongoing man/machine interactions reveal much about a user's preferences and habits, facilitating predictive control of devices which may be subject to a user's confirmation of machine-proposed activity. Such function and capability is applicable to many areas. In a particular example embodiment, such a system is employed in connection with document processing devices.

Suitable document processing devices include scanners, copiers, printers, plotters and fax machines. More recently, two or more of these functions are contained in a single device or unit, referred to as a multifunction peripheral (MFP) or multifunction device (MFD), which may also serve as an e-mail or other information routing gateway. As used herein, MFP includes any device having one or more document processing functions such as those noted above. While example embodiments described herein refer to MFPs, it will be appreciated that they may be also applied to single use devices, such as a printer.

MFPs can be expensive, particularly when multiple devices are required for service. In addition to unit costs, MFPs may consume resources, such as paper, toner, ink or power. It is therefore advantageous to share one or more MFPs among multiple users, via workstations, notebook computers, tablets, smartphones, or any other suitable computing device. Interaction between users and MFPs, between MFPs and servers, or between computing devices, can occur over any wired or wireless data infrastructure, such as local area networks (LANs), wide area networks (WANs) such enterprise WANS or the Internet, or point-to-point communication paths, such as universal serial bus (USB), infrared, Bluetooth, or near field communication (NFC).

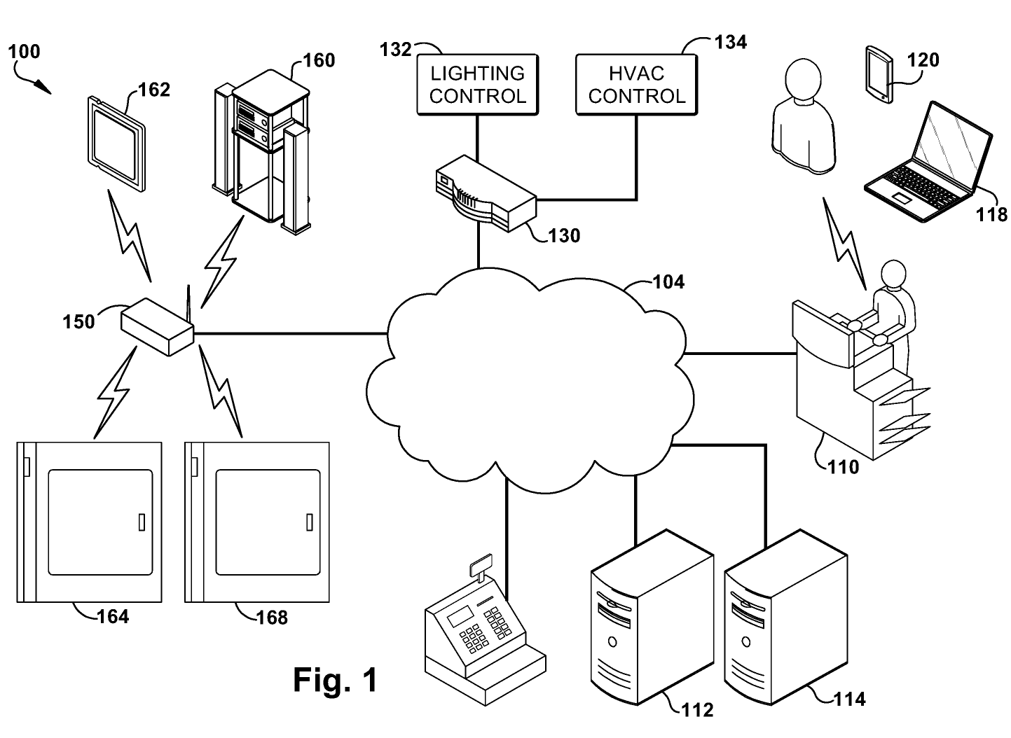

Turning now to FIG. 1, illustrated is an example embodiment of a network 100. Network 100 is suitably comprised of any data transfer infrastructure, such as those described above. In the illustrated example embodiment, network 100 includes a wide-area network 104, such as the Internet. Network 100 provides data connection to one or more document processing devices, such as MFP 110. MFP 110 includes a user interface, example embodiments of which will be detailed below. One or more servers, such as those illustrated by servers 112 and 114 are also in data communication with the network 100. User interaction is suitably provided locally or remotely with any suitable data device, such as computers, tablets, PDAs, smartphones, or the like. By way of example, a user suitably interfaces via a computer 118 or tablet 120.

Also illustrated in data communication with network 100 in the example embodiment of FIG. 1 is network interface 130 which suitably provides a gateway to monitored or intelligent environmental devices, such as a lighting control system 132, a heating/ventilation/air-conditioning control system 134, or devices such as thermostats, humidistats, thermometers, barometers or the like. Also suitably in data communication with network 100 is information obtained from a retailer or financial institution that provides additional, historic information.

The example embodiment of FIG. 1 also illustrates a network interface 150 represented as a wireless access point. Network interface 150 suitably provides a local area network having data connection with entertainment systems, computers or appliances. In the example, these devices include an entertainment system, such stereo system 160, a television 162 and appliances, such as washer 164 and dryer 168. It is understood that any suitable device may be implemented, either locally or remotely, such as stoves, ovens, microwaves, alarms, refrigerators or the like. Device connectivity, such as described above, has recently been described using the term: “the Internet of Things”.

Generally, devices can connected to the wide-area network 104 via any suitable means as would be understood in the art. For example, as illustrated, a point of sale terminal 130 is shown as being connected to the wide-area network 104.

As will be understood further below, devices in the example network 100 have a common ability to detect and report user activity associatively with user identity. In one example embodiment, relative to MFP 110, information is suitably obtained about a user's history of number of copies made, document finishing choices, e-mail destinations, file types, media types, storage preferences, destination devices, document selections, payment processing, and the like. By way of particular example, further user histories or propensities can be gleaned from entertainment systems which may report a user's taste in music or movies, appliances with may report cooking habits, thermostats which report environmental preferences, point of sale terminals which report purchase history and other devices that report on things such as a user's eating habits, sleep habits, travel habits, shopping habits and the like.

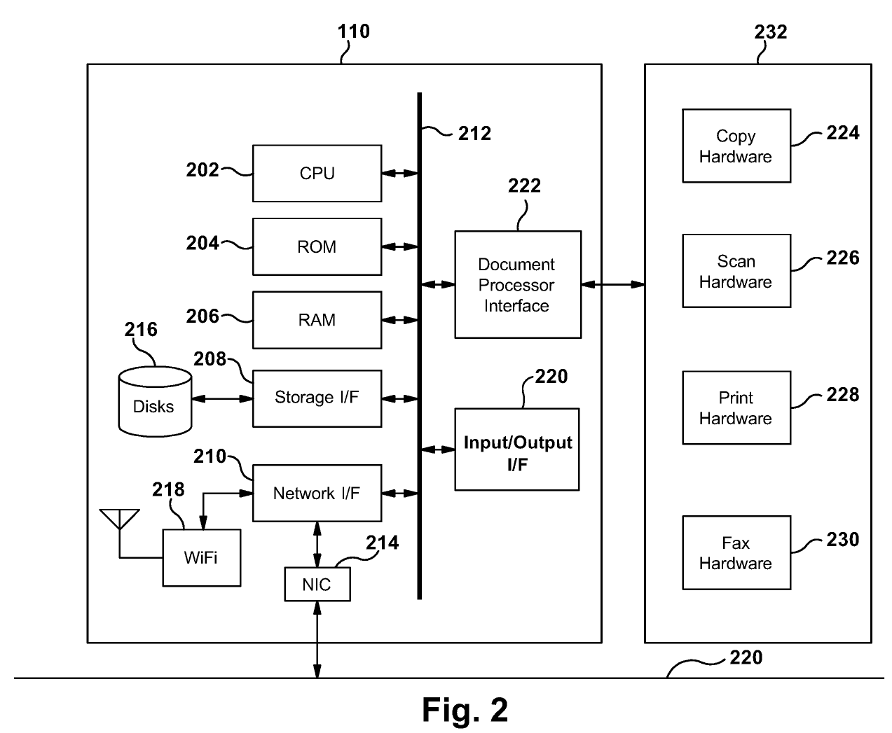

Turning now to FIG. 2, illustrated is an example of a digital processing system 200 suitably comprised within MFP 110. Included are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection via network interface connection (NIC) 214, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), telephone line, or the like. NIC 214 and wireless network interface 218 suitably provide for connection to an associated network 220.

Processor 202 is also in data communication with a user input/output (I/O) interface 220 which provides data communication with user peripherals, such as displays, keyboards, mice, track balls, touch screens, or the like. Also in data communication with data bus 212 is a document processor interface 222 suitable for data communication with MFP functional units. In the illustrate example, these units include copy hardware 224, scan hardware 226, print hardware 228 and fax hardware 230 which together comprise MFP functional hardware 232. It will be understood than functional units are suitably comprised of intelligent units, including any suitable hardware or software platform.

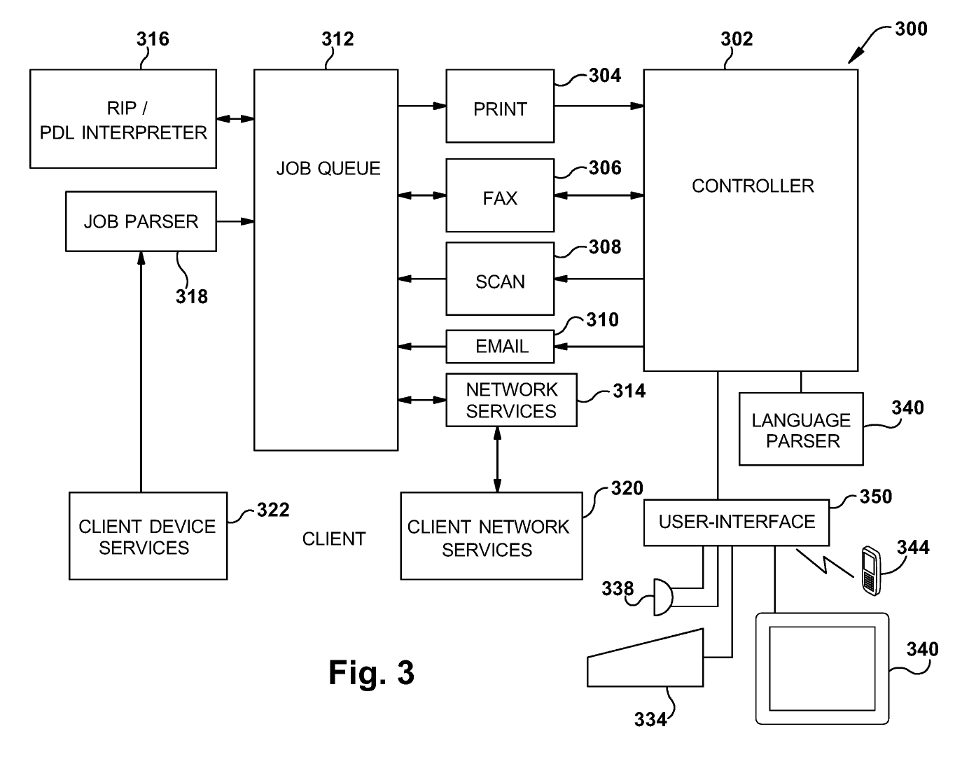

Turning now to FIG. 3, illustrated is an example embodiment of functional components 300 of a suitable MFP, such as MFP 110 of FIG. 1. Controller 302 functions as the computing capabilities of the MFP. The controller interfaces with functions including print 304, fax 306, scan 308 and e-mail 310. Jobs associated with these functions are suitably processed via job queue 312, which in turn outputs jobs for appropriate processing. By way of example, jobs may be interfaced with a raster image processor/page description language interpreter 316 for output on tangible media. Jobs may also enter the job queue 312 via job parser 318 which suitably interfaces with client devices services 322, or via network services 314 which suitably interfaces with client network services 320.

Controller 302 also suitably interfaces with a language parser 340 operable to parse language, such as natural language in text form or from captured audio. Controller 302 also communicates with user interface 350 which suitably provides human interaction. By way of example, human input is suitably electro-mechanical, such was with keyboard 334, or audible, such as with microphone 338. It will be appreciated that any suitable input may be used, such as a mouse, trackball, light pen, touch screen, gesture sensors, or the like. A visible rendering of text or graphical output is suitably output to video display terminal 340. Also, remote interfaces, such as with smartphone 344 allow for interfacing with the controller 302.

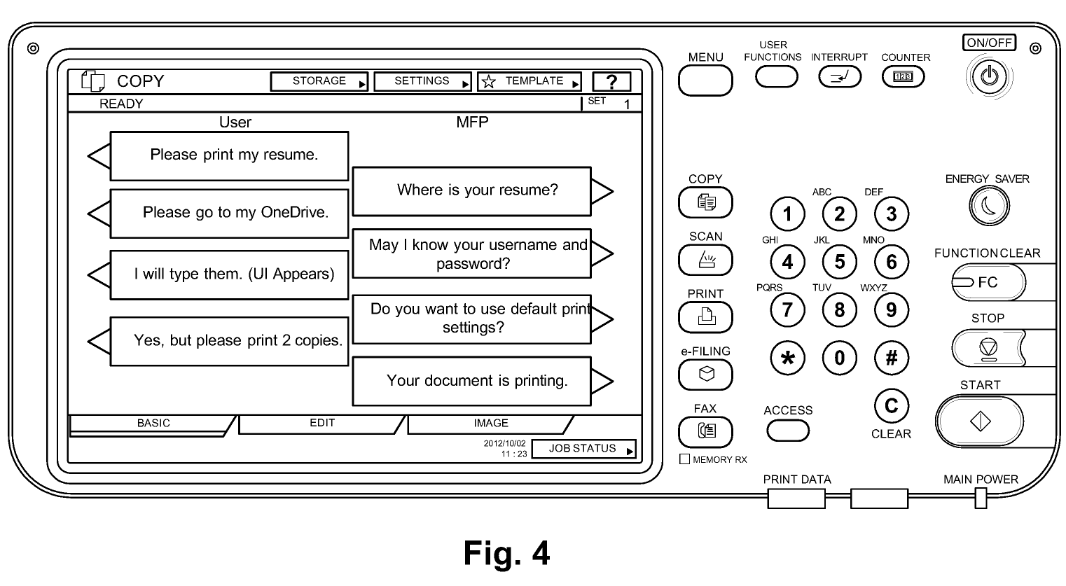

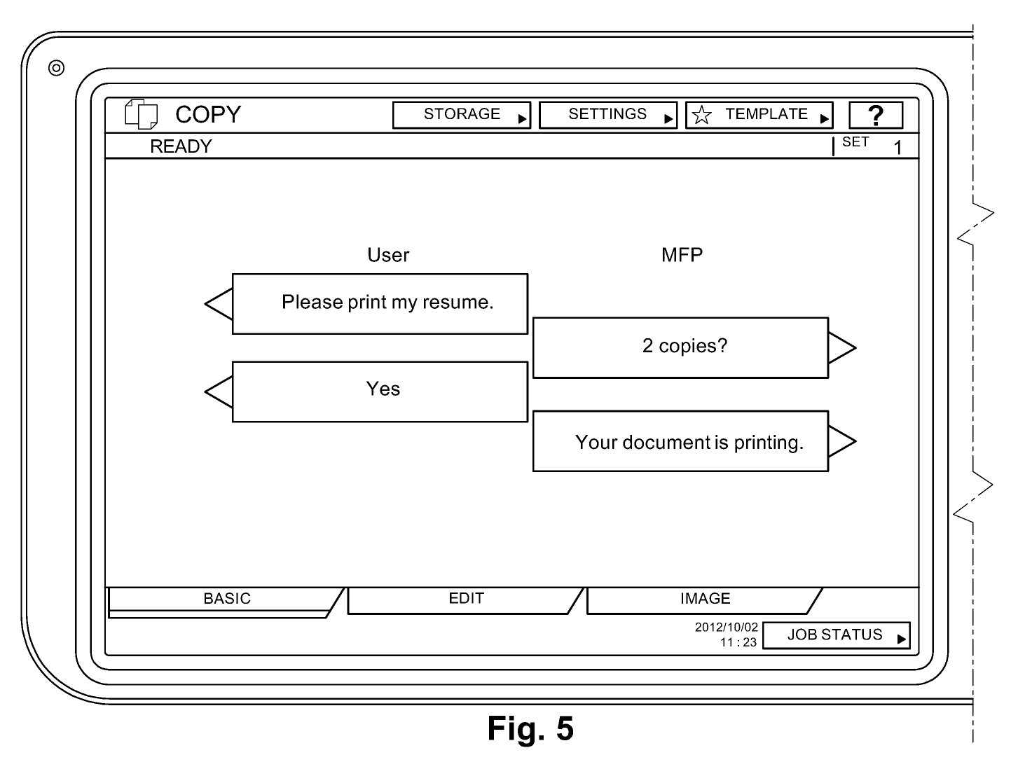

FIGS. 4-10 illustrate example embodiments of human-device interaction in connection with the teachings herein. In the example of FIG. 4, a user interacts with an MFP via a natural language interface in a dialog 400. As illustrated with the dialog, the MFP is enabled to receive a user request for a document processing operation comprising printing an employment resume, and soliciting required information to complete the operation and update the user relative to progress. The MFP solicits and remembers the user's credentials and print settings to complete the operation in the example. The next time that the user solicits a print operation for an employment resume' in dialog 500 of FIG. 5, the MFP recalls background information supplied earlier, solicits any additional information needed, and proceeds to complete the operation with minimal instruction and inconvenience to the user.

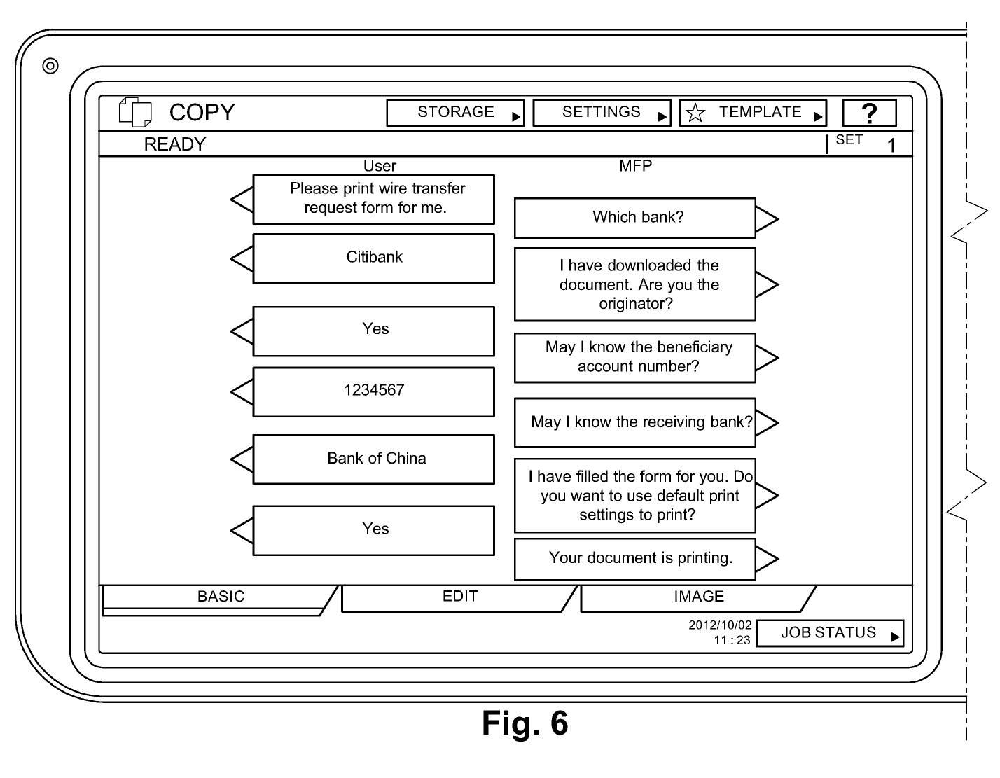

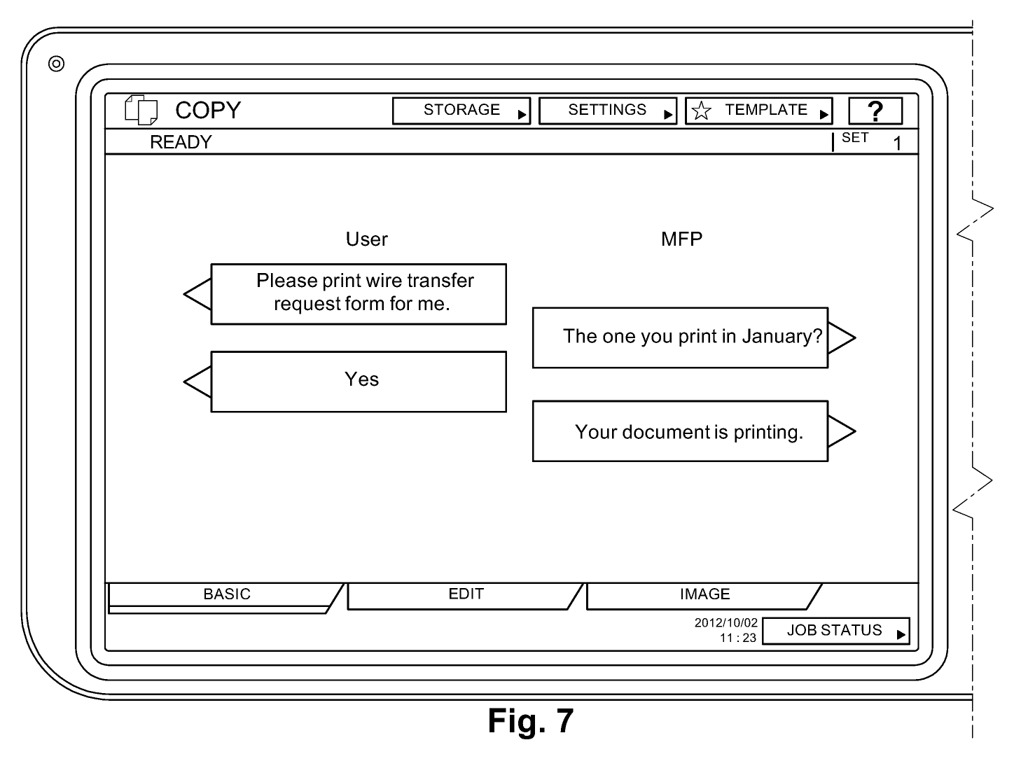

Turning to the example of FIG. 6, similar natural language instruction is associated with a wire transfer payment in dialog 600. FIG. 7 illustrates dialog 700 wherein expedited processing is accomplished for the user during a subsequent, analogous operation.

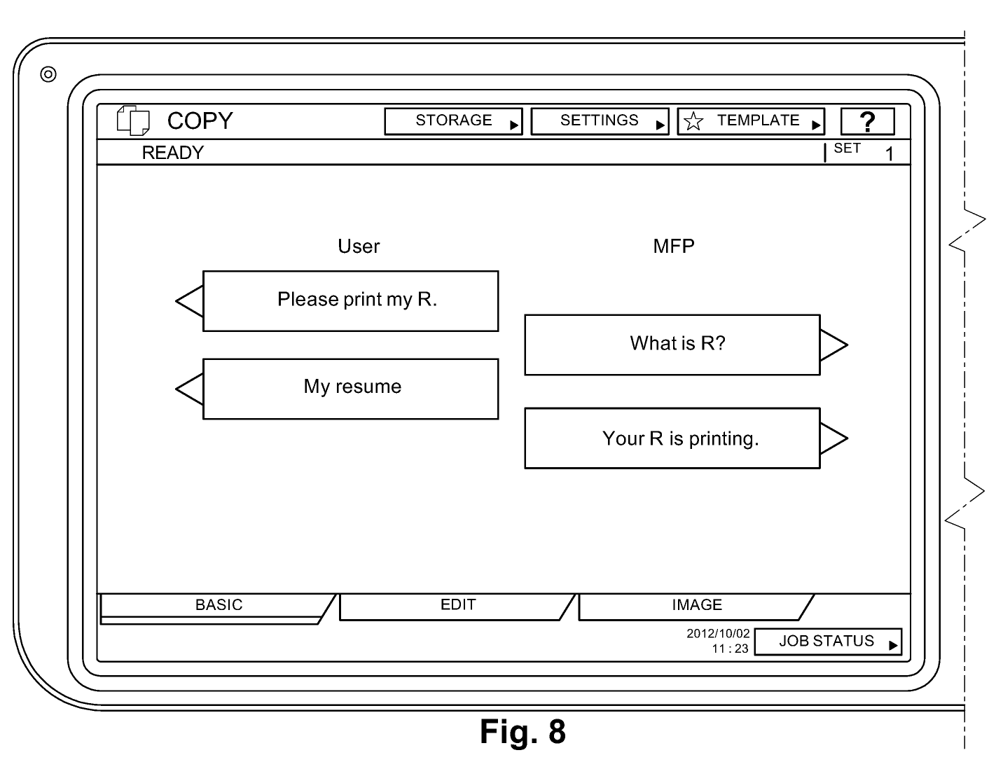

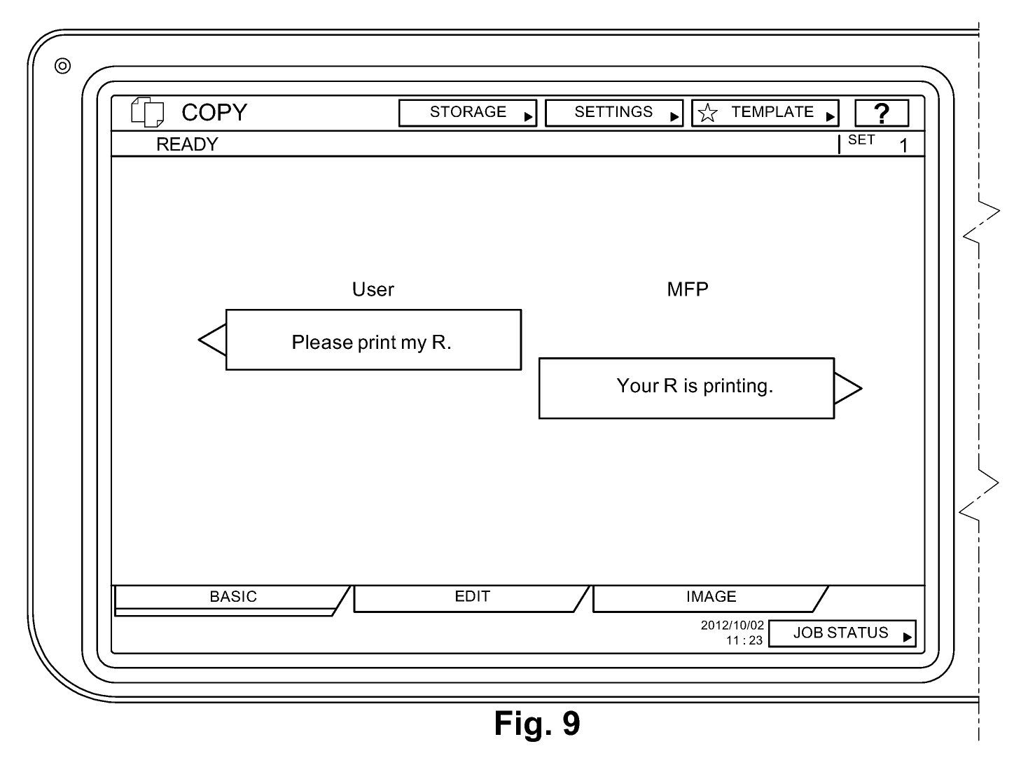

FIG. 8 illustrates another example embodiment dialog 800. In the example, a user provides information as to “R” being shorthand for an employment resume'. In FIG. 9, a subsequent dialog 900 facilitates printing of an employment resume' using the now-established shorthand.

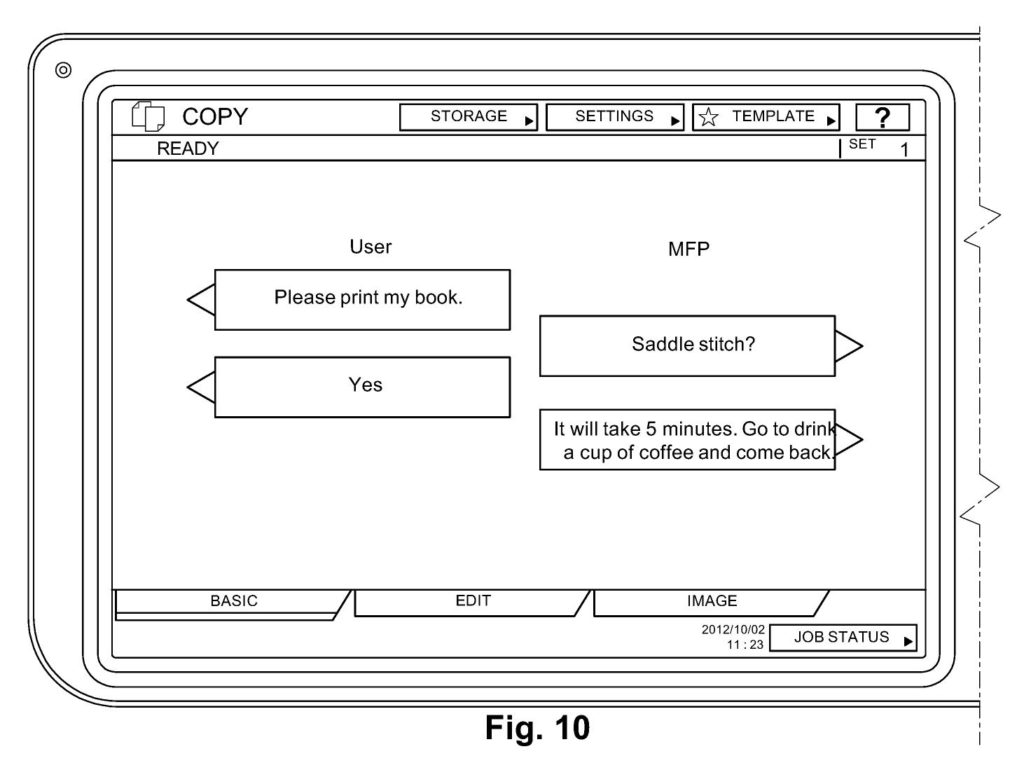

FIG. 10 illustrates an example dialog 1000 wherein a user requests a document processing operation for a book printing, and wherein the MFP inquires further as to particulars of the print operation. The document processing operation is commenced with the user's instruction and the MFP provides processing time information to the user in a user-friendly manner.

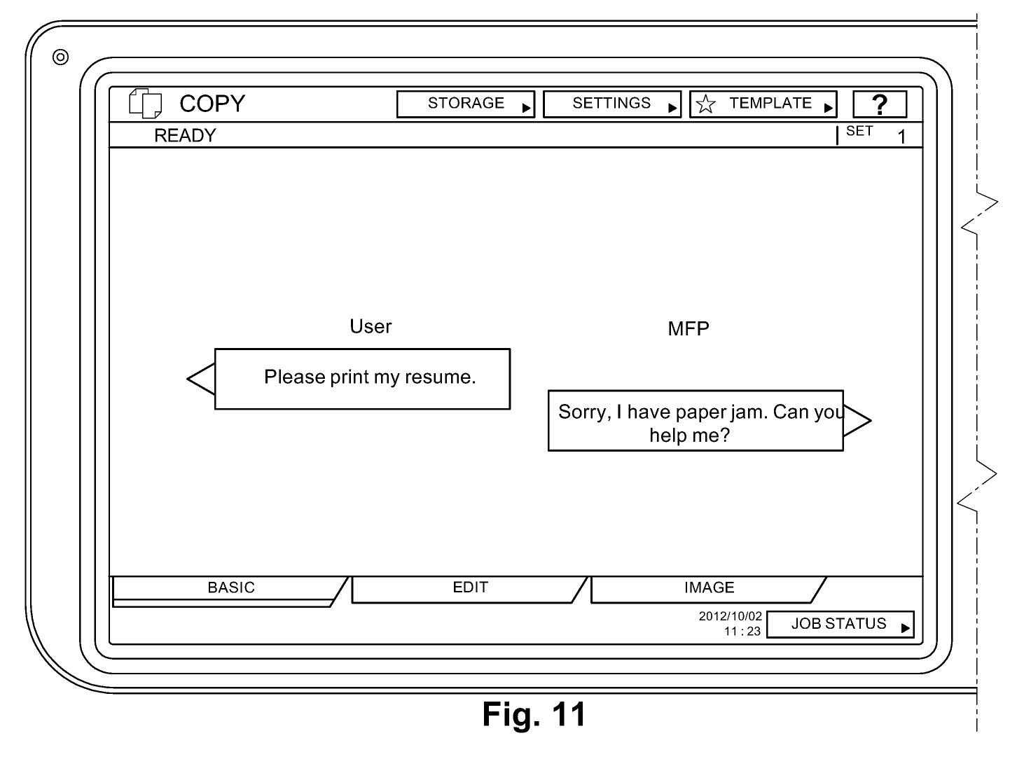

In the example illustration of FIG. 11, dialog 1100 includes a user request for a document processing operation which results in the MFP informing the user of problems associated with processing. In the illustration, human intervention is required to address a paper jam, and the user's assistance is requested.

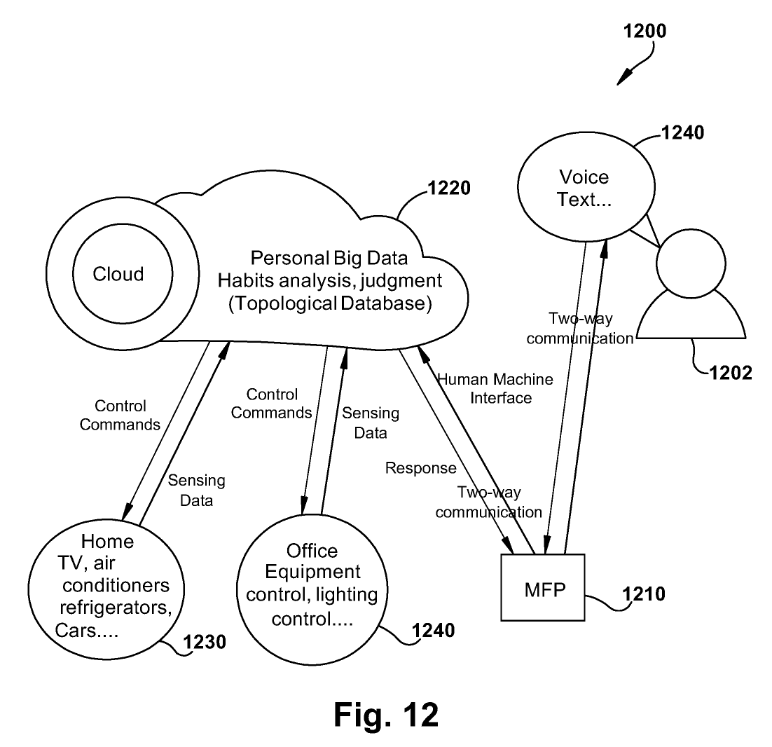

Turning now to FIG. 12, illustrated is an example embodiment of user/device interaction 1200 wherein data obtained from home or office equipment associated with a user is used by an MFP to better service that user. In the illustrated example, user 1202 engages in a natural language dialog with MFP 1210 for completion of one or more tasks. MFP 1210 has external data relative to the user 1202 available to it, suitably obtained via a wide-area network, such as the Internet, illustrated by data cloud 1220. Data available to the MFP 1210 via data cloud 1220 is suitably obtained from any remote location associated with the user 1202, such as from home 1230 or office 1240. Any or all relevant data thus obtained by MFP 1210 is suitably used in conjunction with servicing a user's request 1240 to provide enhanced ease and efficiency, with a better user experience.

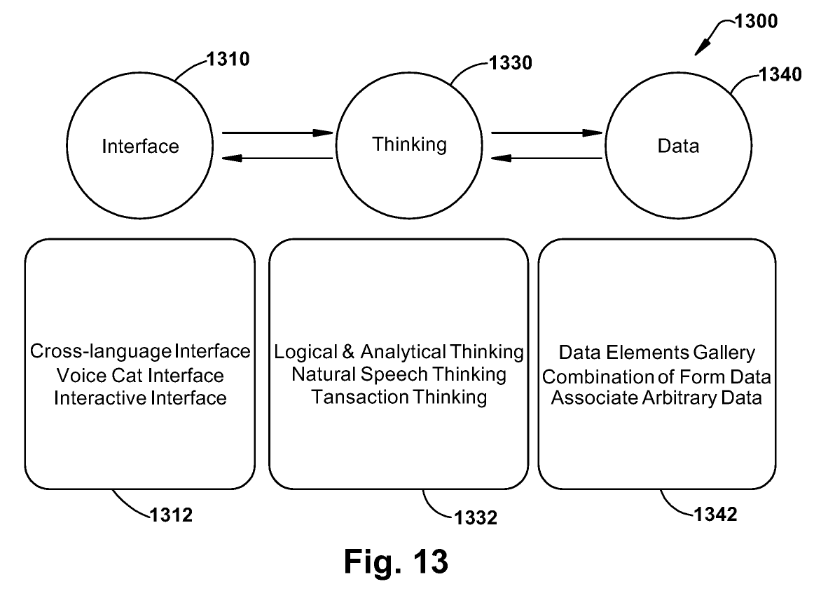

FIG. 13 is block diagram of an example embodiment illustrating machine processing 1300 for realizing the forgoing. An interface 1310 is suitably enabled with functionality set 1312, suitably including a cross-language interface for accommodating voice input in different languages or dialects, a voice catalog interface to ascertain a user's identity, and an interactive interface to allow for device control and dialog such as is illustrated in the examples above. Interface 1310 is suitably voice-based, and can include voice recognition, such as via voice print identification or generation. However, it is understood that any suitable input may be implemented. Suitable output may be audible, such as verbal, or may be text based on an associated display. Input is also suitably obtained in text format, or from any suitable format employing an application program interface.

Interface 1310 facilitates input to facilitate machine thinking 1330, suitably comprised of logical or artificial intelligence-based analysis 1332. Data 1340, available from different areas as detailed above, is suitably subject to processing 1342. Data 1340 includes functionality for parsing of syntax, parsing of semantics, and analysis of people, things, times and places. This facilitates distinction between action and emotion, by way of example. Machine thinking 1330 includes functionality for obtaining information for various, associated elements, suitably through application of artificial intelligence. Self-learning, conjecture and assumptions further enhance the user experience. Self-learning suitably comprises active self-learning of things such as user habits and preferences, as well as passive self-learning, wherein the user inputs or selections are accepted and retained.

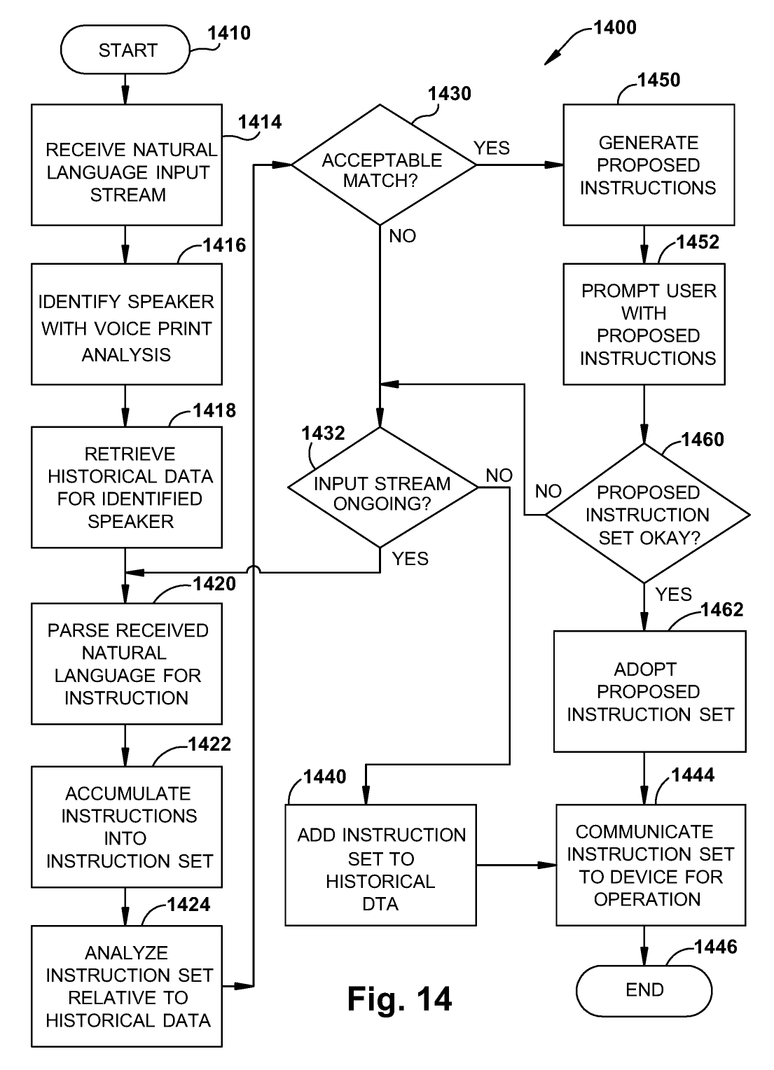

Turning now to FIG. 14, illustrated is a flowchart of an example embodiment of device operation 1400 corresponding to that detailed above. The process commences at block 1410, and proceeds to block 1414 wherein a natural language input stream is received. Next, at block 1416, an identity of a speaker is determined, suitably via voiceprint analysis. If a speaker cannot be identified, a new entry and associated voiceprint for that user are suitably made for future use. Next, at block 1418, historical data, if any, is obtained for an identified speaker. The speaker's speech is parsed at block 1420 and input, such as instructions, are accumulated into an instruction set at block 1422. Next, at block 1424, received instructions or other input are analyzed relative to historical data, if any, from prior interaction with that user.

If there is no acceptable match between prior and current instructions determined at block 1430, a check is made at block 1432 to determine if more user input is forthcoming. If so, progress returns to block 1420. If not, then the new instructions are added to the historical data set at block 1440 and these instructions are implemented at block 1444. Then, the operation is suitably terminated at 1446.

If an acceptable match between current and prior instructions are determined at block 1430, proposed instructions are generated accordingly at block 1450. Next, the user is prompted with these proposed instructions at block 1452. If the user does not confirm the proposed instructions at block 1460, operation returns to block 1432 to progress as detailed above. If the user confirms the proposed instructions at block 1460, the proposed instruction set is adopted at 1462, and the system proceeds to block 1444 for execution, and then operation terminates at block 1446.

While certain embodiments have been described, these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A device comprising:
a user interface;
a processor configured to process natural language input received via the user interface for each of a plurality of discrete user sessions,
the processor configured to identify users associated with each of the plurality of discrete user sessions, and
the processor configured to associate processed natural language input with identification data corresponding to each user associated therewith;
a language parser configured to extract instruction data from the processed natural language input;
a memory configured to store user input data corresponding to processed natural language input, the memory configured to store instruction data associated with identification data; and
an output configured to communicate an output instruction to control an associated device,
wherein the processor is further configured to compare instruction data stored in the memory from a prior user session with instruction data received from a subsequent user session for a common user, and
wherein the processor is further configured to generate the output instruction based on the comparison.

2. The device of claim 1 further comprising a microphone, and wherein the natural language input is comprised of user speech received by the microphone.

3. The device of claim 1 wherein the instruction data from the subsequent user session is comprised of a sequence of discrete user instructions,
wherein the processor is configured to generate a proposed output instruction prior to completion of the sequence,
wherein the processor is configured to generate a prompt to a user associated with the subsequent user session relative to the proposed output instruction,
wherein an input is configured to receive selection data from the user responsive to the prompt, and
wherein the processor configured to selectively communicate the proposed output instruction via the output in accordance with received selection data.

4. The device of claim 3 wherein the associated device is comprised of a document processing device configured to operate in accordance with a received output instruction.

5. The device of claim 4 wherein the processor is configured to generate statistical data corresponding to a plurality of prior user sessions for the common user, and wherein the proposed output instruction is generated in accordance with the statistical data.

6. The device of claim 5 further comprising:
a network interface configured to receive device usage data associated with an identified user corresponding to that user's prior operation of a remote device, and
wherein the processor configured to the proposed output instruction in accordance received device usage data.

7. The device of claim 6 wherein the network interface is configured to communicate the proposed output instruction to the remote device in accordance with the selection data.

8. The device of claim 5 wherein the processor is further configured to communicate a sequence of output instructions to the document processing device, and wherein the sequence of output instructions is derived from the plurality of prior user sessions.

9. A method comprising:
storing, in a memory, historical data corresponding to prior sequences of document processing device instructions, wherein historical data for each prior sequence is stored associatively with an identifier of an corresponding user;
receiving a sequence of document processing instructions from a current user into a document processing device controller during a user session;
identifying the current user;
comparing, in at least one processor associated with the controller, the sequence of instructions as they are received with historical data associated with the current user;
generating at least one proposed instruction as a result of the comparing;
generating a prompt to the current user corresponding to the proposed instruction;
receiving selection data corresponding to the prompt from the current user; and
generating a document processing device control signal in accordance with the selection data.

10. The method of claim 9 further comprising:
receiving voice input from the current user;
analyzing, via the at least one processor, received voice input during the user session;
identifying the current user in accordance with voice analysis during the user session; and
parsing, via the at least one processor, the voice input to determine the sequence of document processing device instructions contained therein as they are received during the user session.

11. The method of claim 9 further comprising:
receiving, via an associated network, device data corresponding to prior operation of at least one remote device by the current user; and
generating the at least one proposed instruction in accordance with received device data.

12. The method of claim 9 further comprising:
calculating statistical data from the historical data; and
generating the at least one proposed instruction in accordance with the statistical data.

13. A system comprising:
an input configured to receive identification data corresponding to an identity of an associated user;
an interface configured to receive a sequence of natural language instructions from an identified user;
a parser configured to sequentially parse received natural language instructions to form a corresponding sequence of device instructions;
a processor and associated memory,
the processor configured to analyze the sequence of device instructions relative to pre-stored sequences of device instructions associated with the identified user, and
the processor configured to generate a sequence of proposed instructions in accordance with an analysis;
a display configured to display data representative of the sequence of proposed instructions; and
an output configured to selectively send a selected sequence of proposed instructions to an associated device in accordance with a received user selection data,
wherein the input is further configured to receive the user selection data corresponding to acceptability of the sequence of proposed instructions.

14. The system of claim 13 wherein the interface is comprised of a microphone and a digitizer configured to digitize voice input to the microphone input to generate the natural language instructions.

15. The system of claim 13 wherein the interface is configured to receive the natural language instructions comprised of a digital text string.

16. The system of claim 13 further comprising:
a network interface configured to receive selection commands corresponding to selections made by the associated user in a previous operation of one or more of a plurality of network devices, and
wherein the processor is further configured to generate the proposed instructions in accordance with received selection commands.

17. The system of claim 16 wherein the selection commands are comprised of selections associated with operation of a home appliance by the associated user.

18. The system of claim 13 further comprising:
an interface configured to receive position information corresponding with a location of the associated user, and
wherein the processor is configured to generate the proposed instructions in accordance with the position information.

19. The system of claim 13 further comprising:
an interface configured to receive purchasing information corresponding with purchases made by the associated user, and
wherein the processor is configured to generate the proposed instructions in accordance with the purchasing information.

20. The system of claim 19 wherein the purchasing information corresponds to costs associated with document processing device operation.
